(19) United States
(12) Patent Application Publication
(10) Pub. No.: US 2009/0177641 A1
(43) Pub. Date: Jul. 9, 2009

(54) PATIENT MONITORING NETWORK AND METHOD OF USING THE PATIENT MONITORING NETWORK

(75) Inventor: Jayaram Raghavan, Bangalore (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/968,897

(22) Filed: Jan. 3, 2008

(51) Int. Cl. G06F 7/06; G06F 15/16; G06F 17/30

(52) U.S. Cl. 707/5; 709/203; 707/E17.009; 707/E17.017

(57) ABSTRACT

In one embodiment, a method of using a patient monitoring network is provided. The method comprises steps of storing an association data at a primary server unit, the association data mapping a caregiver with at least one patient associated with the caregiver, storing an object data of at least one patient at a patient monitor coupled to the primary server unit, the object data comprising an identification data and a patient data of the patient, receiving a query at the patient monitor by the caregiver, fetching the association data of the caregiver from the primary server unit, displaying the identification data of at least one patient associated with the caregiver at the patient monitor, obtaining a selection for the patient at the patient monitor and displaying the patient data of the patient at the patient monitor.

### FIELD OF THE INVENTION

The invention relates generally to a patient monitoring network and more particularly to a method of enhancing the workflow at a patient monitoring network.

### BACKGROUND OF THE INVENTION

In a healthcare establishment, in order to view the physiological parameters of a patient (such as Heart Rate, SpO2) caregivers are expected to remember an identification number of the patient (or an identifier such as room number and bed number) for each of their patient associations. This is difficult in a dynamically changing hospital environment. In practice, human caregivers can remember identification details such as names and physical characteristics of the patient better than the identification number of the patient. During a shift change in the healthcare establishment, patients may be handed over to another caregiver such as temporary nursing staff. Such a scenario may give rise to miscommunication, leading to errors.

Further, each healthcare establishment maintains an electronic record of the medical history of each patient, the medical history includes drug therapy information of a patient. The drug therapy information may include the details of type, dosage and schedule of one or more drugs administered to the patient. This is important information to keep track of, regarding the drugs administered to the patient during his/her stay at the healthcare establishment. However, during the stay of the patient in the healthcare establishment, there may be several changes incorporated into the type and/or dosage and/or schedule of drugs administered to the patient. Prior to incorporation of each change, authentication is to be made by one of the caregivers approving the change. One disadvantage associated with the prior art methods is, the process of capturing information about who authenticated a change in administering a particular drug and/or dosage to the patient and when, is carried out manually.

Another limitation experienced in the healthcare establishment is difficulty in keeping track of mobile caregivers such as physicians and consultants in a dynamically changing healthcare establishment environment. Pagers and other communication devices are typically used to keep track of the caregivers. However, these communication devices are additional pieces of electronic equipment to keep track of the caregiver in the healthcare establishment and can fail due to various reasons such as low battery, mishandling and misplacing. Moreover, these communication devices can introduce concerns of infection in high-acuity monitoring zones.

One of the solutions provided in the prior art to simplify the workflow in a healthcare environment suggests using additional IT equipment (Tablet PCs, PDAs) by the caregivers. However, addition of IT equipment introduces one or more levels of complexity in the operation of the healthcare environment.

Thus, there exists a need in the healthcare environment to simplify the clinical workflow thereby providing an efficient system for maintaining record of the patient data, medication data and location information of the caregiver.

### BRIEF DESCRIPTION OF THE INVENTION

The above-mentioned shortcomings, disadvantages and problems are addressed herein which will be understood by reading and understanding the following specification.

In one embodiment, a method of using a patient monitoring network is provided. The method comprises storing an association data at a primary server unit, the association data mapping a caregiver with at least one patient associated with the caregiver, storing an object data of at least one patient at a patient monitor coupled to the primary server unit, the object data comprising an identification data and a patient data of the patient, receiving a query at the patient monitor by the caregiver, fetching the association data of the caregiver from the primary server unit, displaying the identification data of at least one patient associated with the caregiver at the patient monitor, obtaining a selection for the patient at the patient monitor and displaying the patient data of the patient at the patient monitor.

In another embodiment, a patient monitoring network is provided. The patient monitoring network comprises a primary server unit configured to store an association data, the association data mapping a caregiver with at least one patient associated with the caregiver, a patient monitor coupled to the primary server unit, an information tag coupled to the caregiver and a tag reader coupled to the patient monitor. The patient monitor is capable of reading the information tag and querying the primary server unit for data associated with the information tag.

In yet another embodiment, a computer program product stored in a computer-readable storage medium for execution by a computing device is provided. The computer program product provides a method of using a patient monitoring network. The computer program product includes computer-readable program code for storing an association data at a primary server unit, computer-readable program code for storing an object data of at least one patient at a patient monitor coupled to the primary server unit, computer-readable program code for receiving a query at the patient monitor by the caregiver, computer-readable program code for fetching the association data of the caregiver from the primary server unit, computer-readable program code for displaying the identification data of at least one patient associated with the caregiver at the patient monitor, computer-readable program code for obtaining a selection for the patient at the patient monitor and computer-readable program code for displaying the patient data of the patient at the patient monitor.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a conceptual view of a communications network of a healthcare establishment, in an embodiment of the invention;

FIG. 2 shows a block diagram of an example of a patient monitoring network, in an embodiment of the invention;

FIG. 3 shows a flow diagram of a method of using a patient monitoring network, in an embodiment of the invention;

FIG. 4 shows a flow diagram of a method of authenticating a change in the medication information of a patient at a patient monitor, in an embodiment of the invention; and

FIG. 5 shows a flow diagram depicting, a method of providing location information of a caregiver, in an embodiment of the invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

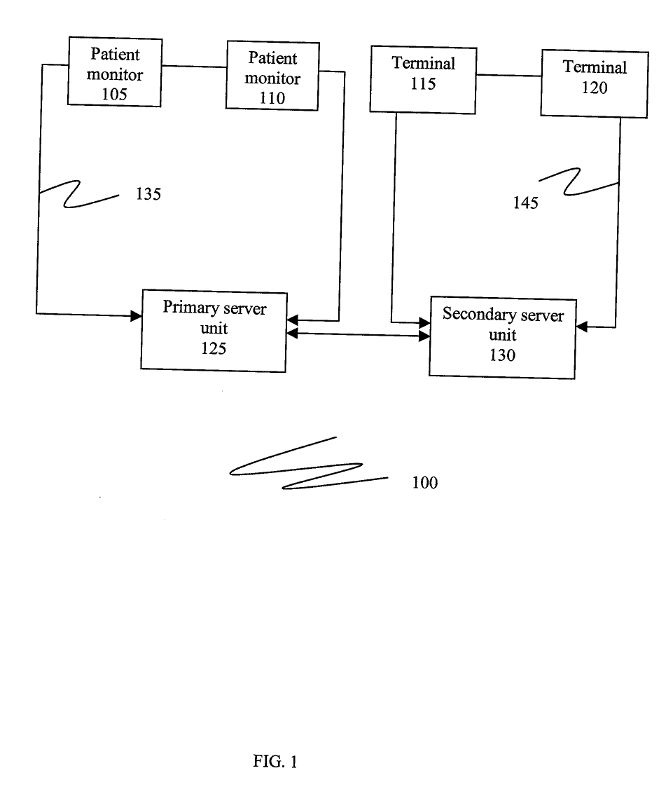

In one embodiment, the invention provides a method of enhancing workflow at a healthcare establishment communications network. As depicted in FIG. 1, the healthcare establishment communications network 100 comprises a combination of a plurality of patient monitors 105 and 110 and a plurality of terminals 115 and 120. The patient monitors 105 and 110 are connected to each other and to a primary server unit 125 via communication links 135. The terminals 115 and 120 may comprise a combination of fixed-wire terminals and mobile terminals, such as workstations, connected to each other and to a secondary server unit 130 via the communication links 145.

The communication links 135 and 145 may include wireless portions. The wireless portions of the communication links 135 and 145 are secure links that may be encapsulated within the communications network 100, as would be the case for a wireless local area network (WLAN) using WLAN access points. In another embodiment, the wireless portions of the communication links 135 and 145 may involve an external network connection.

For ease of reading, the healthcare establishment using network 100 may be referred to as a hospital, but it should be understood that the healthcare establishment using network 100 may be of any size and may consist of a single building or a campus including one or more buildings or pavilions and possibly one or more adjacent areas such as roads and parking lots. Further it should be noted that FIG. 1 depicts only one of many possible architectures for the healthcare establishment communication network 100 and that various other architectures are possible within the scope of the invention.

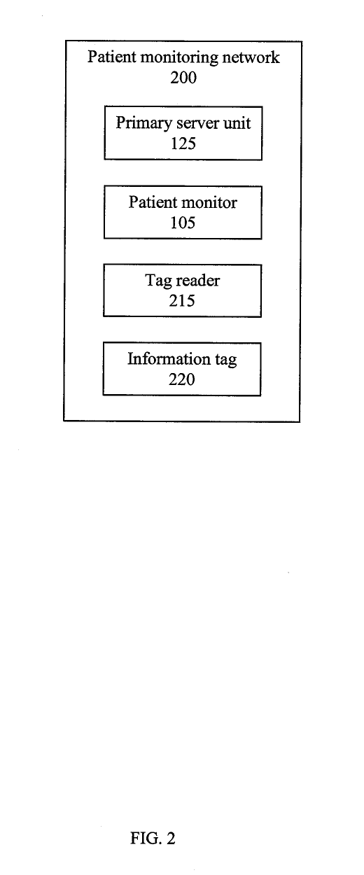

FIG. 2 shows a block diagram of an embodiment of a patient monitoring network 200 that forms a part of the healthcare establishment communication network 100.

The primary server unit 125 comprises a display, a transceiver or a combination of a transmitter and a receiver, and memory storage. The primary server unit 125 receives data from one or more patient monitors 105 and 110, displays this information to the caregivers at a central monitor, and stores the data for archival and analysis purposes. Further, archival records associated with a given patient can be transferred to another central monitoring system or an auxiliary system either through wireless communications or through a hardwired network link.

The patient monitors 105 and 110 provide sensors for monitoring a number of physiological parameters including but not limited to ECG (electrocardiogram), NIBP (non-invasive blood pressure), SpO2 via pulse oximetry, respiration, temperature, invasive pressure lines, gas monitoring, and cardiac output. The patient monitors 105 and 110 can each operate independently as a monitoring device, as well as transmit data to and receive monitoring control signals from the primary server unit 125. The network transport used by the patient monitoring network 200 can be a proprietary transport protocol or it can be based on an Open XML transport protocol such as XMPP.

The patient monitors 105 and 110 are accessed by a plurality of “caregivers” who are mobile within the hospital. The term “caregiver” is used to denote the broad category of individuals who may require access to the communications network 100 in the execution of their duties pertaining to diagnosis and/or treatment of one or more patients. While not intended to be an exhaustive list, typically caregivers can include physicians, radiologists, pharmacists, interns, nurses, laboratory technicians and orderlies, who are all involved in patient diagnosis and/or treatment.

Referring back to FIG. 2, the patient monitoring network 200 further comprises an information tag 220 coupled to the caregiver and a tag reader 215 coupled to the patient monitor 105. The patient monitor 105 is configured for reading the information tag 220 via the tag reader 215 and querying the primary server unit 125 for information associated with the information tag 220.

In another embodiment, the tag reader 215 can be integrated with the patient monitor 105. The tag reader 215 can optionally be configured to allow the caregiver, who requires information about a specific patient, to access the object data of the patient by scanning the information tag 220 onto the tag reader 215.

The information tag 220 associated with the caregiver may comprise an identification data of the caregiver and the authentication information for the caregiver. The information tag 220 may be one of a radio frequency identifier (RFID), a barcode label and a magnetic stripe tag embedded in an adhesive tag that adheres to the caregiver in a tamper resistant fashion. The information tag 220 can be referred to as being “wirelessly detectable”, in the sense that their presence can be detected by the tag reader 215 without requiring that a fixed-wire connection be established between the information tag 220 and the tag reader 215.

In the non-limiting example of implementation shown in FIG. 1, the primary server unit 125 stores a caregiver database that includes the association data, associating each caregiver with at least one patient associated with the caregiver. The patient monitor 105 stores a patient database. The secondary server unit 130 stores a departmental database and an equipment database. Further, the primary server unit 125 is separated from the secondary server unit 130 to protect data integrity on the patient monitoring network 200. This is typically done by allowing connections to the patient monitoring network 200 through designated gateways.

The caregiver database stores information regarding the caregivers. In one embodiment, the information regarding the caregiver includes a unique caregiver identifier (e.g., an employee number) for the caregiver, as well as “authentication information” for the caregiver. The authentication information can be, for instance, a password and/or data indicative of a biometric characteristic such as a fingerprint or retina scan of the caregiver. Other information regarding the caregiver may include an identification number of the information tag 220 that is expected to be worn by the caregiver. Further, other information regarding the caregiver may include, a profile of the caregiver, which defines certain qualifications of the caregiver, as well as access privileges defining types of information that the caregiver is allowed to access. For example, if the caregiver is a physician, he may have privilege to access advanced information about the patient when compared to a nurse. Still further information regarding the physician can include a list of patients under the responsibility of the physician and/or a list of facilities commonly used by the physician.

In the specific non-limiting case where caregiver is a physician, the information stored in the caregiver database may include one or more of the profile of the physician, the access privileges of the physician, a list of patients under the responsibility of the physician, information (e.g., an electronic health record, or a portion thereof) related to one or more patients in the list of patients under the responsibility of the physician.

The patient database stores information on the hospital's patients such as the object data of each patient registered at the hospital. The object data comprises the identification data of the patient such as identity, age, height, weight, sex, race, family and genetic medical data, medical history, physical handicaps, known medical conditions, known medical allergies, and current ailment conditions such as symptoms, duration, temperature, blood pressure, pulse rate, blood test data, urine test data, physician observations and the like.

Further, the object data includes the patient data that provides a resource of information regarding the patient's diagnosis, treatment, and medications. Thus the patient data may comprise patient medication prescriptions and medication schedules for the patient's specified treatment such as medication names, manufacturers, dosage amounts, dosage schedules, and common side effects.

In one embodiment, the patient database is configured as a database of electronic health records, whereby the information on each patient is stored as an electronic health record (EHR) of the patient. For example, the EHR of a given patient can include information regarding: the long-term and short-term health history of the patient; the treatment and/or surgical history of the patient; one or more diagnostics on the condition of the patient, ongoing and/or planned treatments or surgery for the patient, results of one of more tests performed on the patient (e.g., blood test results, images from medical imaging techniques (e.g. x-rays, MRI images, etc.), or results from any other conceivable test performed on the patient); as well as other information specific to the patient such as admissions records. Due to the sensitive and confidential nature of this information, access to the information contained in the patient database is subject to various authentication and access privilege verifications.

The departmental database (there may be more than one) stores information related to a respective department of the hospital. For instance, the radiology department of the hospital may have its own database storing x-ray images and/or images from other modalities generated as a result of tests performed on patients of the hospital. Similarly, other departments of the hospital, such as the cardiology, chemotherapy, physiotherapy, pharmacy, emergency room, admissions, billing, maintenance, supplies, administration, kitchen, cafeteria, and any other conceivable department of the hospital, may have their own databases storing information pertaining to their respective nature and activities.

The equipment database stores information on the hospital's equipment such as patient monitors 105 and 110 and medical devices. For example, the equipment database comprises a plurality of fields for each piece of equipment, including a unique equipment identifier (e.g., a serial number). Still other information regarding the specific piece of equipment may include, an equipment type (such as “terminal”, “fixed terminal”, “mobile terminal”, “PDA”, “fetal heart monitor”, etc.) and a predetermined location of a static piece of equipment, if known.

Further, the primary server unit 125 comprises suitable software, hardware and/or control logic for implementing a variety of functions, including a data mining function.

The purpose of the data mining function is to retrieve from the caregiver database, the patient database, the departmental database and the equipment database, information to be made available at the patient monitors 105 and 110 for sessions established between the primary server unit 125 and the patient monitors 105 and 110. Further, the data mining function is operative to modify information contained in the above-mentioned databases or add new information to these databases as a result of sessions established between the primary server unit 125 and the patient monitors 105 and 110. In this way, the data mining function acts as a conduit between the databases and the caregivers.

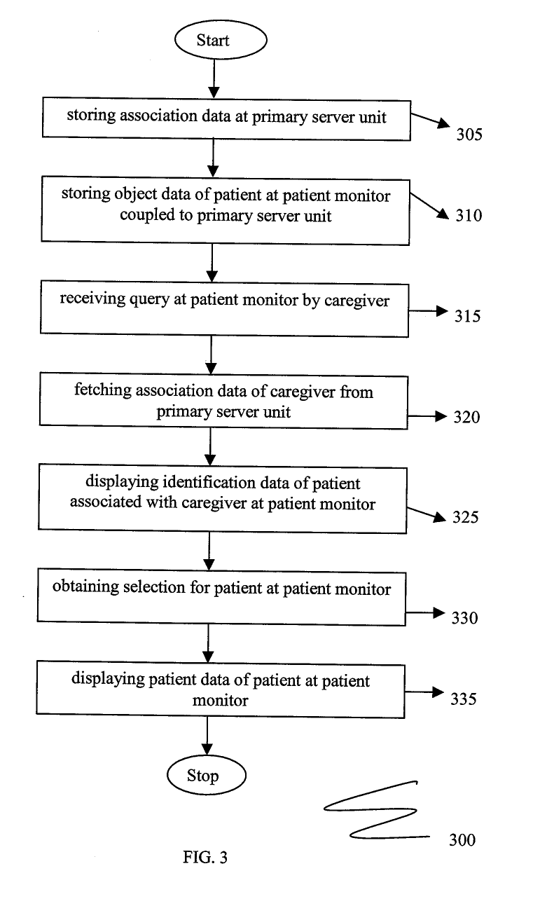

In one embodiment as depicted in FIG. 3, the invention provides a method of using a patient monitoring network 200. The method 300 comprises steps of storing the association data at a primary server unit 125 step 305, storing the object data of at least one patient at the patient monitor 105 step 310, receiving a query at the patient monitor 105 by the caregiver step 315, fetching the association data of the caregiver from the primary server unit 125 step 320, displaying the identification data of at least one patient associated with the caregiver at the patient monitor 105 step 325, obtaining a selection for the patient at the patient monitor 105 step 330 and displaying the patient data of the patient at the patient monitor 105 step 335.

As described above, the caregiver database associates the identification number of the caregiver with the identification details of the patients associated with the caregiver. Thus, the information mapping the identification number of the caregiver with that of the patients associated with the caregiver is tracked from the association data maintained at the primary server unit 125. The caregiver desiring to view the patient data sends a query to the primary server unit 125 via the patient monitor 105 to display details of the patients associated with the caregiver. The caregiver then selects a patient based on his/her requirement. The selection is then transmitted to the primary server unit 125, which in response to the selection by the caregiver displays the patient data of the selected patient.

In one embodiment, each patient monitor 105 is associated with a single patient in a department at any given time, however the patient monitor 105 provides the facility to view the patient data of a patient associated with another patient monitor 110, through an option provided in a menu displayed at the patient monitor 105. The caregiver may be provided with an option to view the identification data of each patient associated with each patient monitor 105 and 110 present in the healthcare establishment communication network 100. The caregiver may view the patient data by selecting the identification data of the patient associated with the patient monitor 110, from the menu displayed at the patient monitor 105. Subsequent to obtaining the selection from the caregiver, the patient monitor 105 may directly query the patient monitor 110, for information associated with the patient, bypassing the primary server unit 125.

In another embodiment, in order to view the patient data such as, physiological parameters of a patient associated with the caregiver, the caregiver may not establish his/her identity using the information tag. However, the need to establish the identity may surface when the caregiver wishes to access the patient data of a patient associated with another caregiver.

In one embodiment, in response to monitored patient physiological parameters, or based on communications between the patient and a first caregiver, the first caregiver may transmit new instructions or prescription information to the primary server unit 125 via the communication link 135. This allows a second caregiver to approve or reject the modifications suggested by the first caregiver in the patient's treatment.

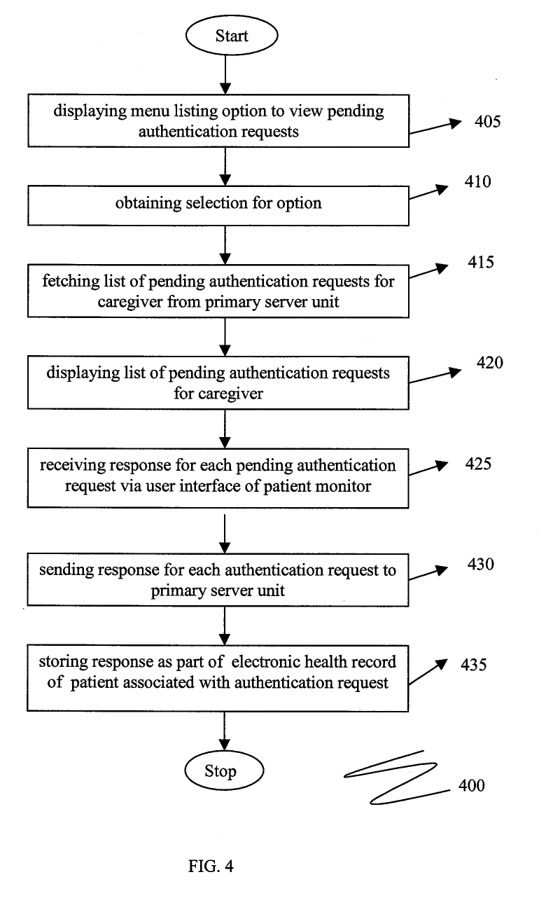

Accordingly, in another exemplary embodiment, the invention provides a method of authenticating a change in the medication information of a patient, at the patient monitor 105. The method is depicted in FIG. 4. The method 400 comprises steps of displaying a menu at the patient monitor 105 listing an option to view pending authentication requests step 405, obtaining a selection for the option step 410, fetching a list of pending authentication requests for the caregiver from the primary server unit 125 step 415, displaying a list of pending authentication requests for the caregiver at the patient monitor step 420, receiving a response for each pending authentication request via a user interface of the patient monitor 105 step 425, sending the response for each authentication request to the primary server unit 125 step 430 and storing the response as a part of the electronic health record of the patient associated with the authentication request step 435.

As described above, the caregiver upon establishing his/her identity at the patient monitor 105 is able to view a menu with an option to view pending authentication requests. Subsequent to selection of this option by the caregiver, the patient monitor 105 fetches a list of pending authentication requests for the caregiver from the primary server unit 125 and displays a menu of pending authentication requests for the caregiver. The caregiver responds to each authentication request via the user interface. The user interface can be a trim knob and the response can be an approval or a rejection. Following the response of the caregiver to each authentication request, the authentication information is relayed to the primary server unit 125 where it becomes part of the patient's electronic health record (EHR).

In yet another embodiment, the patient monitors 105 and 110 and the terminals 115 and 120 of the healthcare establishment communication network 100 can be employed to track the location information of a caregiver at the healthcare establishment communication network 100. Instant Messaging technologies are widely used by businesses to keep track of location information (“presence”) of users on the network. The same techniques can be used in the healthcare establishment communication network 100 to efficiently keep track of the caregivers and their patient associations.

Thus, in one embodiment, the invention provides a method to adapt the terminals 115 and 120 to track the location information of the caregivers in the hospital, in order to facilitate simplification of the clinical workflow.

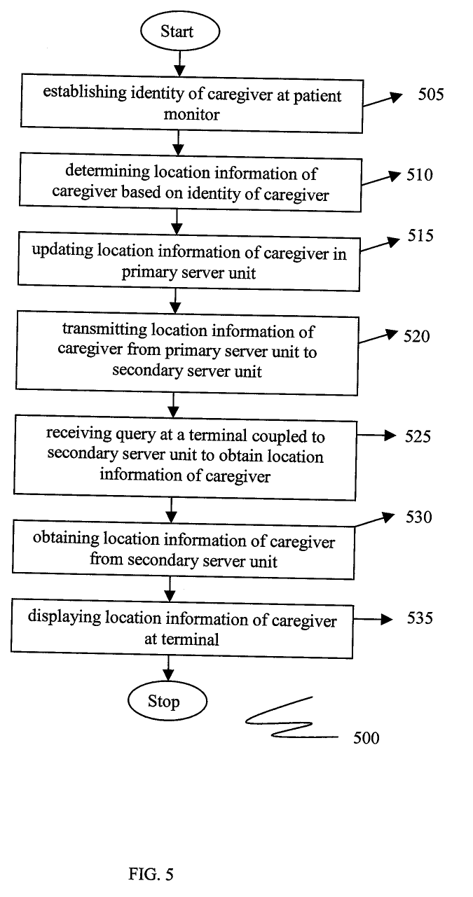

The method of tracking the location information of the caregiver is described in FIG. 5. The method 500 comprises steps of establishing identity of the caregiver at the patient monitor 105 step 505, determining a location information of the caregiver based on the identity of the caregiver step 510 and updating the location information of the caregiver in the primary server unit 125 step 515. Further the step 505 of establishing identity of the caregiver at the patient monitor 105 involves receiving the identification data of the caregiver via the information tag associated with the caregiver.

Subsequent to establishing the identity of the caregiver at the patient monitor 105, the tag reader 215 generates range messages indicative of the distance between the information tag 220 and the tag reader 215. The generation of the range messages can be based on the intensity of the received signals, or on the round-trip travel time. Thus, the range messages may contain information permitting the determination of range (distance) between the tag reader 215 and the information tag 220.

Initially, the primary server unit 125 stores the location information of each caregiver entering the healthcare establishment communication network 100. A copy of the location information is maintained at the secondary server unit 130, following the transmission of the location information from the primary server unit 125 to the secondary server unit 130 step 520. The primary server unit 125 updates the location information of the caregiver at the secondary server unit 130 as and when the caregiver scans the information tag 220 to establish his/her identity at one of the patient monitors 105 and 110 present in the healthcare establishment communication network 100. The operation of scanning the information tag 220 provides the patient monitor 105 with the location information of the caregiver, similar in fashion to the instant messaging networks. The location information of the caregiver is further updated in the secondary server unit 130.

In a scenario where a user needs to locate the caregiver, the user can query the secondary server unit 130 via the terminals 115 and 120 to obtain the last known network location of the caregiver. This is further explained in conjunction with FIG. 5. The method 500 of locating the caregiver further comprises steps of receiving a query at the terminal 115 to obtain the location information of the caregiver step 525, obtaining the location information of the caregiver from the secondary server unit 130 step 530 and displaying the location information of the caregiver at the terminal 115 step 535.

The location information thus obtained can be used in multiple ways. Non-limiting examples include, to track availability of a caregiver and his location in the healthcare establishment. Further, as an extension of the method 500, the secondary server unit 130 can store extension number of a telephone located at proximity to each patient monitor 105 and 110 present in the hospital. A user desiring to contact the caregiver can place a telephone call to the extension number located proximally to the patient monitor 105 based on the location information updated at the secondary server unit 130 suggesting the location of the caregiver to be at the proximity of the patient monitor 105.

Alternatively, the method 500 can be automated if the information concerning the location of various patient monitors 105 and 110 in the patient monitoring network 200 and the hospital phone system are linked together. The information mapping each patient monitor 105 with the extension number of at least one telephone located at close proximity to the patient monitor 105 may be maintained at the secondary server unit 130 for facilitating the automation.

Some of the advantages provided by the invention are listed below. A caregiver desiring to view the patient data of a patient can do so without having knowledge of the identification number associated with the patient. This reduces the burden on the caregiver and possible miscommunication between two caregivers exchanging information about the patient. The automation provided in viewing the patient data, reduces human errors in the hospital workflows thereby providing an efficient, reliable and quality patient care.

Authentication of the caregiver desiring to view the patient data can be carried out at the patient monitor. The authentication process can be further simplified by using a standard set of codes for the steps that may need authentication.

In one of the embodiments, the invention provides a method of maintaining an electronic record of a list of caregivers authenticating a change in the medication information of a patient. Capturing electronic record of who authenticated a change in administering a particular drug and/or dosage to the patient and when is desired for archival and analysis.

Further, the invention provides an advantage of employing the terminals, present in the IT network of the hospital, to display the location information of the caregivers present in the healthcare establishment communication network. Based on the location of the patient monitor last accessed by the caregiver, approximate location information about the caregiver can be made available on the network. This serves as additional information to efficiently locate a particular caregiver in case of emergencies.

This service can be enabled on the patient monitoring network with incremental changes to the software of the patient monitors. The existing patient monitoring networks are being designed to use XML transport for transporting various patient physiological parameters. Adding “presence/location” information may involve an incremental change.

On the other hand, the caregivers can choose to let others know their location information, by voluntarily approaching a patient monitor and swiping the information tag associated with the caregiver. This avoids potential privacy concerns, as the caregiver has control over disclosing his location information to others.

The invention makes use of existing network of patient monitors and terminals present in the healthcare establishment. Further no additional tag readers need to be installed for this application, if the tag reader circuitry is integrated into the patient monitor electronics. Thus, the patient monitoring network needs no additional piece of equipment other than non-contact information tags carried by the caregivers. Further, the advantage of using the information tag includes ability to provide easy sterilization.

The processing power of the patient monitor and spare bandwidth available on the patient monitoring network can be efficiently used without adversely affecting the performance of the patient monitors. Further, these features can be enabled without affecting the life critical data carried by the patient monitoring network.

The various methods described in the invention result in improvement in productivity of caregivers. Considering they are the biggest assets of the healthcare establishment, the improvement in productivity of the caregivers may result in financial gains to the healthcare establishment.

In various embodiments of the invention, a patient monitoring network for a healthcare environment and a healthcare environment using the patient monitoring network are described. However, the embodiments are not limited and may be implemented in connection with different applications. The application of the invention can be extended to other areas, for example communication networks. The invention provides a broad concept of using a patient monitor to view various data, which can be adapted in a similar communication network. The design can be carried further and implemented in various forms and specifications.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of using a patient monitoring network, the method comprising:
storing an association data at a primary server unit, the association data mapping a caregiver with at least one patient associated with the caregiver;
storing an object data of at least one patient at a patient monitor coupled to the primary server unit, the object data comprising an identification data and a patient data of the patient;
receiving a query at the patient monitor by the caregiver;
fetching the association data of the caregiver from the primary server unit;
displaying the identification data of at least one patient associated with the caregiver at the patient monitor;
obtaining a selection for the patient at the patient monitor; and
displaying the patient data of the patient at the patient monitor.

2. The method of claim 1, wherein the patient data comprises at least a portion of an electronic health record of the patient.

3. The method of claim 2, further comprising:
displaying a menu at the patient monitor listing an option to view pending authentication requests;
obtaining a selection for the option;
fetching a list of pending authentication requests for the caregiver from the primary server unit;
displaying the list of pending authentication requests for the caregiver at the patient monitor;
receiving a response for each pending authentication request via a user interface of the patient monitor;
sending response for each authentication request to the primary server unit; and
storing the response as a part of the electronic health record of the patient associated with the authentication request.

4. The method of claim 3, wherein the response comprises an approval.

5. The method of claim 3, wherein the response comprises a rejection.

6. The method of claim 3, wherein the user interface comprises a trim knob.

7. The method of claim 1, further comprising:
establishing identity of the caregiver at the patient monitor;
determining a location information of the caregiver based on the identity of the caregiver;
updating the location information of the caregiver in the primary server unit; and
transmitting the location information of the caregiver from the primary server unit to a secondary server unit.

8. The method of claim 7, further comprising:
receiving a query at a terminal coupled to the secondary server unit to obtain location information of the caregiver;
obtaining the location information of the caregiver from the secondary server unit; and
displaying the location information of the caregiver at the terminal.

9. The method of claim 7, wherein establishing identity of the caregiver comprises receiving an identification data of the caregiver from an information tag associated with the caregiver.

10. A patient monitoring network comprising:
a primary server unit, the primary server unit configured to store an association data, the association data mapping a caregiver with at least one patient associated with the caregiver;
a patient monitor coupled to the primary server unit;
an information tag coupled to the caregiver;
a tag reader coupled to the patient monitor and capable of reading the information tag;
wherein the patient monitor is capable of reading the information tag; and
querying the primary server unit for data associated with the information tag.

11. The patient monitoring network of claim 10, wherein the tag reader is integrated with the patient monitor.

12. The patient monitoring network of claim 10, further comprising:
a secondary server unit coupled to the primary server unit; and
at least one terminal coupled the secondary server unit.

13. A computer program product stored in a computer-readable storage medium for execution by a computing device, the computer program product providing a method of using a patient monitoring network, the computer program product including: computer-readable program code for storing an association data at a primary server unit, the association data mapping a caregiver with at least one patient associated with the caregiver;
computer-readable program code for storing an object data of at least one patient at a patient monitor coupled to the primary server unit, the object data comprising an identification data and a patient data of the patient;
computer-readable program code for receiving a query at the patient monitor by the caregiver;
computer-readable program code for fetching the association data of the caregiver from the primary server unit;
computer-readable program code for displaying the identification data of at least one patient associated with the caregiver at the patient monitor,
computer-readable program code for obtaining a selection for the patient at the patient monitor; and
computer-readable program code for displaying the patient data of the patient at the patient monitor.

14. The computer program product of claim 13, wherein the patient data comprises at least a portion of an electronic health record of the patient.

15. The computer program product of claim 14, further comprising:
computer-readable program code for displaying a menu at the patient monitor listing an option to view pending authentication requests;
computer-readable program code for obtaining a selection for the option;
computer-readable program code for fetching a list of pending authentication requests for the caregiver from the primary server unit;
computer-readable program code for displaying the list of pending authentication requests for the caregiver at the patient monitor;
computer-readable program code for receiving a response for each pending authentication request via a user interface of the patient monitor;
computer-readable program code for sending response for each authentication request to the primary server unit; and
computer-readable program code for storing the response as a part of the electronic health record of the patient associated with the authentication request.

16. The computer program product of claim 15, wherein the response comprises an approval.

17. The computer program product of claim 15, wherein the response comprises a rejection.

18. The computer program product of claim 15, wherein the user interface comprises a trim knob.

19. The computer program product of claim 13, further comprising:
computer-readable program code for establishing identity of the caregiver at the patient monitor;
computer-readable program code for determining a location information of the caregiver based on the identity of the caregiver;
computer-readable program code for updating the location information of the caregiver in the primary server unit; and
computer-readable program code for transmitting the location information of the caregiver from the primary server unit to a secondary server unit.

20. The computer program product of claim 19, further comprising:
computer-readable program code for receiving a query at a terminal coupled to the secondary server unit to obtain location information of the caregiver;
computer-readable program code for obtaining the location information of the caregiver from the secondary server unit; and
computer-readable program code for displaying the location information of the caregiver at the terminal.

21. The computer program product of claim 19, wherein computer readable program code for establishing identity of the caregiver comprises:
computer-readable program code for receiving an identification data of the caregiver from an information tag associated with the caregiver.
